(19) United States
(12) Patent Application Publication
(10) Pub. No.: US 2005/0284271 A1
(43) Pub. Date: Dec. 29, 2005

(54) Apparatus for machining vehicle brake rotors

(76) Inventor: Eddie K. Yau JR., Anaheim, CA (US)

Correspondence Address: Roy A. Ekstrand, Ste. 150, 3158 Redhill Ave., Costa Mesa, CA, 92626, US

(21) Appl. No.: 10/879,697

(22) Filed: Jun. 29, 2004

(51) Int. Cl. B23B 5/04

(52) U.S. Cl. 82/112

(57) ABSTRACT

An apparatus for use in supporting a disc brake rotor upon a brake lathe includes a support arbor having a generally cylindrical flange and an extending elongated cylindrical arbor shaft defining a left hand thread at its end portion. A disc brake rotor is received upon the arbor shaft and supported thereby. A generally cylindrical spacer defining a center bore is received upon the arbor shaft and is secured thereto by a threaded fastener. The assembly of the support arbor, disc brake rotor, spacer and threaded fastener are further supported upon the arbor of a conventional brake lathe. The apparatus facilitates the machining of disc brake rotor surfaces for rotors which include a bearing structure which otherwise prevents support upon a conventional brake lathe.

### FIELD OF THE INVENTION

This invention relates generally to vehicle brake systems and particularly to apparatus utilized in the repair and refurbishing of disk brake systems.

### BACKGROUND OF THE INVENTION

One of the most import systems operative in virtually all vehicles is the brake system. Vehicle and user safety mandates that vehicles be capable of smooth, controlled and rapid stops. In emergency circumstances, the vehicle must be capable of extremely abrupt and extremely precise operation. During normal vehicle operation, the comfort and enjoyment imparted to the vehicle operator is maximized when the vehicle brake system is easy to use, smooth in operation and easily controlled with precision. As vehicles have developed and improved in both speed and power, the stress upon brake systems has correspondingly increased.

Faced with the need to improve brake systems, practitioners in the art have, for the most part, replaced earlier conventional drum brake systems with more effective and efficient disk brake systems. Disk brakes acquire their name from their utilization of a disc-shaped rotor rather than a drum as the operating element of the system. Thus, in disk brake systems, a disc-like rotor is secured to and rotates with the vehicle wheel. Braking force is provided by one or more caliper assemblies which are in some manner fixed to the vehicle structure, such as the vehicle suspension elements. The calipers are typically supported with so-called caliper housing which support brake pads on opposed sides of the rotor. The brake surface portion of the rotor then rotates during wheel rotation through a slot in the caliper housing between the supported brake pads on each side thereof. The caliper assembly further includes hydraulic piston apparatus which is coupled to the brake control or pedal of the vehicle braking system. The brake is operated by the user in applying force to the brake pedal which is communicated by the hydraulic system of the vehicle to the caliper pistons which in response force the brake pads against the opposed sides of the brake rotor. In essence, the rotor is “squeezed” by the opposed brake pads.

In the environment of vehicles such as automobiles, trucks, pick-up trucks and so-called sport utility vehicles and the like, brake pads are worn over time and must be replaced. In addition, brake rotors often become worn, scared or distorted during use. As a result, disk brakes must be periodically serviced and/or repaired. Such servicing usually includes replacement of the brake pads and resurfacing of the portions of the disk brake rotors which are grasped by the disk brake pads. The latter operation usually involves machining the disk surfaces using cutting tools to restore a pair of smooth true surfaces on the rotor.

The processes of machining disk brake rotors often called “turning” the rotors is preferably performed by removing the rotors from the vehicle and employing a brake lathe. Disk brake lathes are somewhat specialized and vary in design. However, in general disk brake rotors are usually secured between opposed conical spacers which captivate the disk brake rotor and impart rotational force exerted by the lathe head.

As disk brake systems have evolved, certain disk brake systems have included a wheel bearing design which can not be supported in a conventional brake lathe. In essence, such wheel bearings preclude the use of the conical adapters previously employed. As a result, such disk brake rotors must instead be machined or turned on the vehicle without removing the rotors. This process of “on-the-vehicle” rotor turning is time consuming and difficult. In addition, an expensive machine is required. As a result, the cost borne by the user in servicing brake systems having rotors which must be turned in this manner may be substantially increased by the service facility.

As a result, there arises a continuing need in the art for an improved apparatus for machining disk brake rotors having the above-mentioned wheel bearing structure.

### SUMMARY OF THE INVENTION

Accordingly, it is a general object of the present invention to provide an improved apparatus for servicing disk brake rotors. It is a more particular object of the present invention to provide an improved apparatus for servicing disk brake rotors which facilitates machining disk brake rotors having an internal bearing structure upon a conventional brake lathe.

In accordance with the present invention, there is provided apparatus for machining a disk brake rotor, the apparatus comprising: a support arbor defining a base flange and an arbor shaft, the arbor shaft having a threaded end portion and the base flange and the arbor shaft defining a center bore therethrough; a spacer defining a spacer bore therethrough; and a threaded fastener defining an internally threaded aperture therethrough, the support arbor being constructed to be received upon a brake lathe arbor and to receive and support disk brake rotor and the spacer and the threaded fastener constructed to secure a disk brake rotor upon the support arbor. In accordance with another aspect of the present invention there is provided apparatus for use in securing a disk brake rotor upon a brake lathe arbor of a brake lathe, the apparatus comprising: a support arbor defining a base flange, an elongated cylindrical arbor shaft having a threaded end and a center bore extending through the base flange and the arbor shaft; a spacer defining a center aperture; a threaded fastener defining a threaded aperture; and means for securing the support arbor to a brake lathe arbor, the support arbor receiving a disk brake rotor upon the arbor shaft against the base flange and the threaded fastener being threaded upon the threaded end to captivate the spacer against a disk brake rotor upon the support arbor. In accordance with another aspect of the present invention there is provided for use in supporting a disk brake rotor upon a brake lathe arbor wherein the brake lathe arbor defines a cylindrical shaft having a first threaded end, apparatus comprising: a support arbor having a base flange, an arbor shaft having a second threaded end and a centerbore through the base flange, the arbor shaft and the second threaded end, the support arbor being received upon the brake lathe arbor by passing the brake lathe arbor through the centerbore; a threaded fastener threadably engaging the first threaded end to secure a disk brake rotor upon the support arbor; and means for securing the support arbor to the brake lathe arbor.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a typical brake rotor supported upon an apparatus constructed in accordance with the present invention;

FIG. 2 sets forth a perspective assembly view of the present invention brake rotor supporting apparatus together with a typical brake rotor of the type to which the invention particularly pertains;

FIG. 3 sets forth a section view of a typical disk brake rotor together with the present invention apparatus for machining vehicle brake rotors taken along section lines 3-3 in FIG. 1;

FIG. 4 sets forth a perspective view of a conventional brake lathe having a conventional disk brake rotor supported by the present invention apparatus for machining disk brake rotors.

### DESCRIPTION OF THE PREFERRED EMBODIMENTS OF THE INVENTION

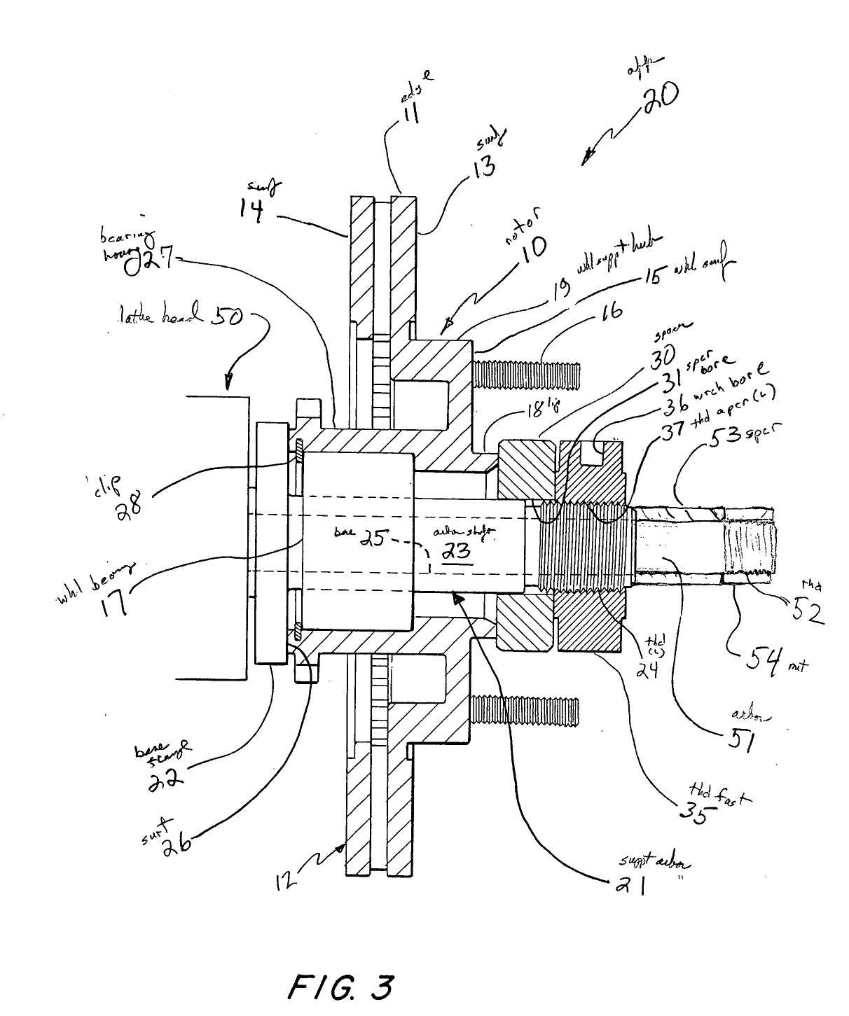

FIG. 1 sets forth a front view of the present invention apparatus for machining vehicle brake rotors generally referenced by numeral 20. Also shown in FIG. 1, is a front view of a typical conventional rotor generally referenced by numeral 10. It should also be noted in FIG. 1 that apparatus 20 and rotor 10 are shown initially supported upon a conventional arbor 51 which in turn is supported by and forms a portion of a conventional brake lathe head 50 (seen in FIG. 3). For purposes of illustration in FIG. 1, additional apparatus which, as is better seen in FIG. 3, cooperates with arbor 51 to fully secure apparatus 20 and rotor 10 has been omitted. Suffice it to note here that a spacer 53 and a threaded nut 54 (seen in FIG. 3) are secured to arbor 51 to complete the attachment of apparatus 20 and rotor 10 to be supporting brake lathe set forth below.

Rotor 10 is fabricated entirely in accordance with conventional fabrication techniques and comprises a metal disc-shaped member having an outer circular edge 11 and a brake disk portion 12. Brake disk portion 12 further defines a pair of opposed brake surfaces 13 and 14 on either side of disk 12. Rotor 10 further includes an extending wheel support hub 19 also cylindrical in shape and having a wheel surface 15 formed thereon. A plurality of threaded wheel studs extend outwardly from wheel surface 15 and support hub 19 and are used in conventional attachment of a vehicle wheel to rotor 10.

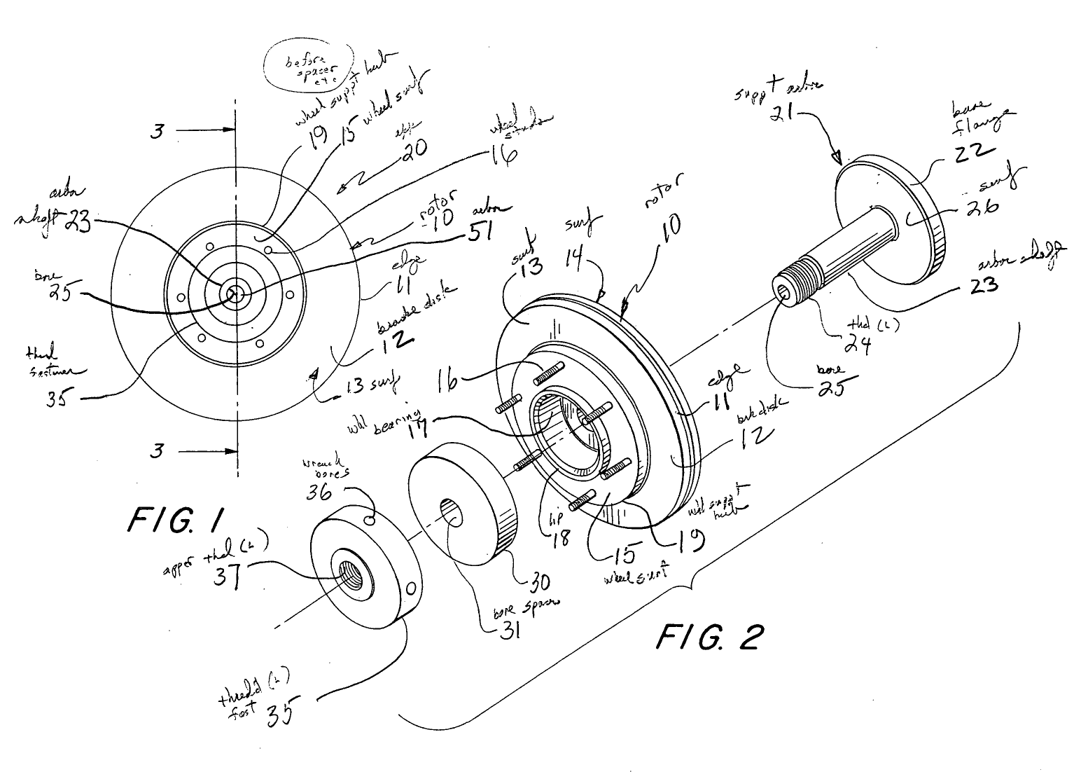

In the front view of FIG. 1, it will be seen that rotor 10 is supported upon an arbor shaft 23 of a support arbor 21 (seen in FIG. 2). Also seen in FIG. 1 is the threaded attachment of a threaded fastener 35 which, as is set forth below in greater detail, is received upon external threads (threads 24 seen in FIG. 2) formed on the end portion of arbor shaft 23. In the preferred fabrication of the present invention, the threads formed upon arbor shaft 23 comprise left hand threads due to the direction of rotation of conventional brake lathes. However, it will be apparent to those skilled in the art that in the event brake lathes rotating in an opposite direction are utilized a corresponding adjustment to a right hand thread for arbor shaft 23 will be employed.

FIG. 2 sets forth a perspective assembly view of rotor 10 together with apparatus 20 fabricated in accordance with the present invention. As described above, rotor 10 is entirely conventional in fabrication and defines a circular outer edge 11 and an annular brake disk 12. Brake disk 12 defines opposed brake surfaces 13 and 14. Rotor 10 further includes a wheel support hub 19 having a wheel surface 15 formed thereon. A plurality of threaded wheel studs 16 are evenly spaced upon wheel surface 15. A wheel bearing 17 is secured within rotor 10 and is fabricated in accordance with conventional fabrication techniques. Finally, rotor 10 defines an extending lip 18 which rises from wheel surface 15.

Apparatus 20 utilizes three basic components which comprise a support arbor 21, a spacer 30 and a threaded fastener 35. Support arbor 21 is formed of a suitable high strength metal material and includes a generally cylindrical base flange 22 having a surface 26 formed thereon. Support arbor 21 further includes a cylindrical arbor shaft 23 defining a center bore 25 therethrough. As is better seen in FIG. 3, bore 25 of support arbor 21 extends entirely through arbor shaft 23 and base flange 22. A plurality of external threads 24 are formed upon the end portion of arbor shaft 23. As mentioned above, the conventional rotational direction of brake lathes of the type to which the present invention pertains rotate in a direction which makes the use of left hand thread for threads 24. The use of left hand threads maintains the tightness of assembly when the present invention apparatus secures rotor 10 in the manner described herein. Suffice to note that in the event a brake lathe rotating in the opposite direction is utilized, threads 24 may be correspondingly adjusted to right hand threads to provide the secure attachment in such case.

Apparatus 20 further includes a generally cylindrical spacer 30 defining a bore 31 therethrough. Finally, apparatus 20 also includes a threaded fastener having a generally cylindrical shape and defining a threaded aperture 37 therethrough. Threaded aperture 37 defines internal threads which cooperate with threads 24 of support arbor 21. Once again, because left hand threads are utilized for threads 24, it will be understood that threaded aperture 37 is correspondingly formed with left hand threads. Fastener 35 further includes a plurality of inwardly extending wrench bores 36 which are utilized by a conventional wrench tool for tightening threaded fastener 35.

The assembly of apparatus 20 shown in FIG. 2 is carried forward by initially placing rotor 10 upon arbor shaft 23 and pressing rotor 10 against surface 26. Thereafter, spacer 31 is placed upon arbor shaft 23 against lip 18. Finally, threaded fastener 35 is threaded onto threads 24 of arbor shaft 23 and tightened using wrench bores 36 and a cooperating conventional wrench (not shown). This assembly may be carried forward initially to form a complete unit which is then placed upon a conventional lathe arbor such as arbor 51 shown in FIG. 3. Alternatively, the assembly may be carried forward by initially placing support arbor 21 upon the lathe arbor such as arbor 51 shown in FIG. 3 and thereafter completing assembly by placing rotor 10 upon arbor shaft 23 followed by spacer 31 and threaded fastener 35. The completion of assembly is better seen by examination of the sectional view shown in FIG. 3.

FIG. 3 sets forth a section view of the present invention apparatus for machining vehicle brake rotors supporting a conventional rotor 10. As described above, rotor 10 is constructed entirely in accordance with conventional fabrication techniques and includes a generally circular brake disk 12 having a circular outer edge 11 and a pair of opposed brake surfaces 13 and 14. Brake surface 13 and 14 are annular in shape and encircle a generally cylindrical wheel support hub 19. Wheel support hub 19 extends from brake surface 13 and supports a plurality of threaded wheel studs 16. In addition, wheel support hub 19 defines a wheel surface 15 and an extending circular lip 18. In further accordance with conventional fabrication, rotor 10 includes a bearing housing 27 integrally formed with wheel support hub 19 and further supporting a wheel bearing 17. Wheel bearing 17 is received within the interior of bearing housing 27 and is secured by an expandable clip 28. The latter is received within a groove formed within the interior of bearing housing 27.

In accordance with the present invention, apparatus 20 includes a support arbor 21 having a cylindrical base flange 22 from which a cylindrical arbor shaft 23 extends. Base 22 and shaft 23 define an internal bore 25 extending entirely through shaft 23 and base 22. Arbor shaft 23 further defines a threaded portion having a plurality of left hand threads 24 formed thereon. Bore 25 extends through the end portion of shaft 23 and threads 24.

A conventional brake lathe head 50 includes an outwardly extending generally cylindrical arbor 51 having a plurality of threads formed thereon. Lathe head 50 rotates arbor 51 in accordance with conventional lathe operation.

In further accordance with the present invention, support arbor 21 is received upon arbor 51 of lathe head 50 by passing arbor 51 through bore 25. With base flange 22 positioned against the outer surface of lathe head 50 and with arbor 51 of lathe head 50 passing through bore 25, spacer 53 is positioned upon arbor 51 against the end of support arbor 21. Thereafter, nut 54 is threaded onto the end of arbor 51 captivating spacer 53 against the end of support arbor 21 and binding support arbor 21 to arbor 51. Support arbor 21 is now positioned upon lathe head 50. In further accordance with the present invention, a rotor 10 is positioned upon arbor shaft 23 of support arbor 21 and is forced against surface 26 of base flange 22. Thereafter, with rotor 10 positioned upon arbor shaft 23 such that wheel bearing 17 rests upon shaft 23, spacer 30 is passed over spacer 53 and nut 54 and is positioned against lip 18 as arbor shaft 23 extends through spacer bore 31. Thereafter, threaded fastener 35 having an internally threaded aperture 37 is also passed over spacer 53 and nut 54 and is threadably received upon threads 24 of arbor shaft 23. Threaded fastener 35 is secured against spacer 30 and tightened with sufficient force to confine the combination of spacer 30 and rotor 10 upon arbor shaft 23 against surface 26 of base flange 22. This tightening process is enhanced due to the plurality of wrench bores 36 formed in threaded fastener 35. As an alternative fabrication, the length of arbor shaft 23 may be chosen to remove the need for spacer 30. In such event, threaded fastener 35 is then tightened directly against lip 18.

As mentioned above, the securing of rotor 10 upon lathe head 50 is accomplished by placing spacer 30 upon support arbor 21 and thereafter securing threaded fastener 35 upon the threaded end of support arbor 21 using a spanner wrench. Sufficient tightening force is applied to threaded fastener 35 to bind the combination of rotor 10 against base flange 22. As an alternative fabrication, the length of arbor 51 may be selected to avoid the need for spacer 53. In this event, spacer 53 is omitted from apparatus 20 and nut 54 is configured to tighten directly against threaded fastener 35.

At this point, arbor 10 is properly secured to lathe head 50 and the rotation of arbor 51 of lathe head 50 will produce a corresponding rotation of apparatus 20 together with brake rotor 10.

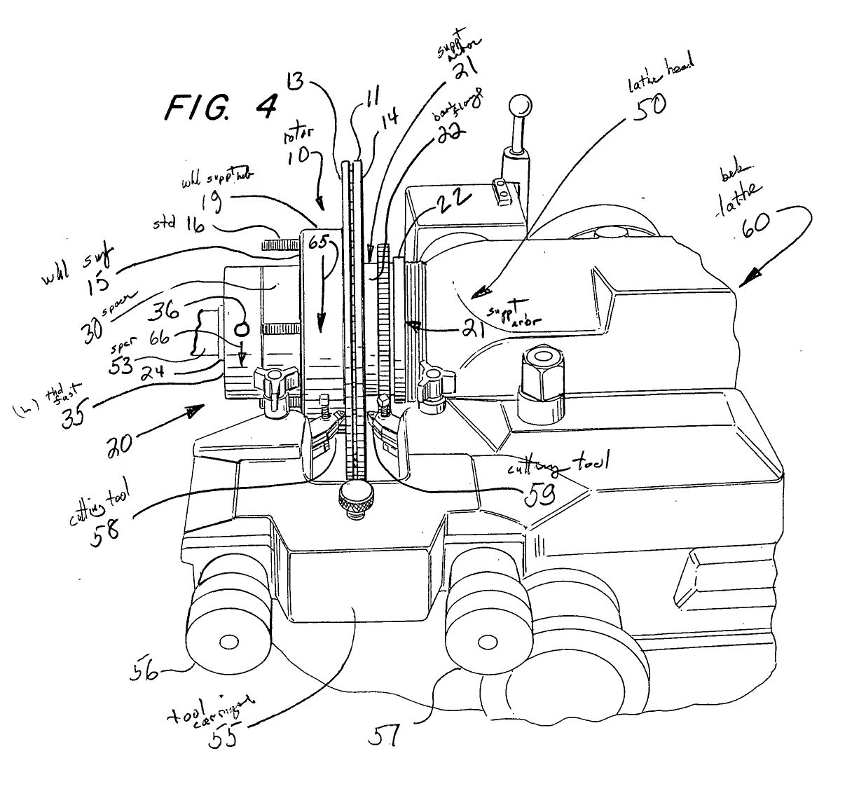

As mentioned above, in the preferred fabrication of the present invention and assuming lathe head 50 rotates arbor 51 in the direction indicated by arrow 65 in FIG. 4, the use of a left hand thread for threads 24 upon arbor shaft 23 and cooperating threads within threaded aperture 37 maintain fastener 35 in a generally “self tightening” attachment. That is to say the torch applied by lathe head 50 to arbor 51 and thereby rotor 10 and apparatus 20 tends to cause threaded fastener 35 to tighten rather loosen. Of course it will be apparent to those skilled in the art that if any opposite direction of rotation is chosen, a right hand thread is preferably used in place of left hand threads described above.

In accordance with an important aspect of the present invention, apparatus 20 securely maintains rotor 10 in a concentric arrangement with arbor 51 of lathe head 50. In further accordance with the present invention, apparatus 20 does not require the removal of wheel bearing 17 and thus provides substantial savings and efficiency. Finally, the present invention apparatus enables the user to employ an otherwise entirely conventional brake lathe in a process which is familiar and well known to virtually all brake service personnel. The result is a substantial saving in labor and time which in turn of course translates to lower costs to the consumer for the brake servicing.

FIG. 4 sets forth a perspective view of a conventional brake lathe 60 supporting a conventional lathe head 50 which in turn supports the combination of a rotor 10 and the present invention apparatus 20.

It will be noted that brake lathe 60 and lathe head 50 cooperate with a tool carriage 55 which in turn supports a pair of cutting tools 58 and 59. In this manner, brake lathe 60 is able to simultaneously cut both surfaces on disk rotor 10. A plurality of operative controls such as control adjustments 56 and 57 are utilized in positioning and moving cutting tools 58 and 59. Once again, cutting tools 58 and 59 together with their respective supports form conventional apparatus typically found in brake lathes such as brake lathe 60.

With respect to the present invention, support arbor 21 having base flange 22 is secured to and received upon arbor 51 (seen in FIG. 3) of lathe head 50. In the above-described assembly, brake rotor 10 having outer edge 11 and brake surfaces 13 and 14 is received upon support arbor 21 as described above in FIG. 3. As is also described above, brake rotor 10 includes a generally cylindrical wheel support hub 19 from which a plurality of threaded wheel studs extend. Wheel support hub 19 defines a wheel surface 15. In further accordance with the present invention, a generally cylindrical spacer 30 is received upon arbor shaft 23 (seen in FIG. 3). In further accordance with the present invention, a left hand threaded fastener 35 is threaded upon threads 24 of arbor shaft 23. Threaded fastener 35 is tightened upon threads 24 to secure spacer 30 and rotor 10 upon support arbor 21 using wrench bores 36 and a conventional tool (not shown). A spacer 53 is secured against the end of threads 24 of arbor shaft 23 as set forth above in FIG. 3. As a result, the combination of rotor 10, support arbor 21, spacer 30 and threaded fastener 35 is secured to and rotatable with arbor 51 of lathe head 50.

In accordance with conventional machining practice, cutting tools 58 and 59 are positioned with respect to brake surfaces 13 and 14 to provide the desired level of machining cut upon each surface. Thereafter, in accordance with conventional machining techniques, tool carriage 55 together with cutting tools 58 and 59 are moved against surfaces 13 and 14 as rotor 10 is rotated in the direction indicated by arrow 65. The objective in machining surfaces 13 and 14 is to provide smooth true flat surfaces which are optimum for performance of the brake system which rotor 10 is utilized in.

In accordance with the present invention, a conventional brake lathe 60 having a lathe head 50 and supporting cutting tools 58 and 59 is able to operate in a conventional high efficiency machining process to recondition surfaces 13 and 14 of rotor 10. The machining operation is maintained with sufficient precision to ensure proper surfacing of rotor 10. In addition, the entire operation but for the use of apparatus 20 is carried forward in a conventional brake rotor turning operation. As a result, little if any additional skill is required by the operator and the entire process is maintained in a highly cost efficient and time and labor saving activity.

In further accordance with the present invention, removal of rotor 10 from the attachment to lathe head 50 is carried forward in essentially the reverse of the above-described process as each successive rotor is placed upon support arbor 21, secured thereto, machined and then removed from support arbor 21 . Accordingly, rotor 10 is removed by initially removing threaded fastener 35 by rotating threaded fastener 35 in the direction indicated by arrow 66. Once threaded fastener 35 has been removed, spacer 30 is withdrawn from arbor shaft 23 (seen in FIG. 3) which in turn facilitates removing rotor 10 from support arbor 21 while leaving support arbor 21 secured to arbor 51. With rotor 10 removed, the user may install an additional rotor and repeat the above-described installation process to then machine the next disk brake rotor. The use of apparatus 20 facilitates this conventional machining process to properly face surfaces 13 and 14 in a manner consistent with previously encountered disk brake rotors.

What has been shown in an apparatus for machining vehicle brake rotors which facilitates operations upon the disk brake rotors removed from the vehicle. The apparatus shown is constructed to operate with a conventional brake lathe and is further constructed to facilitate machining the disk brake rotor surfaces using conventional machine apparatus and cutting tools. The present invention apparatus avoids the need for utilization of highly specialized and expensive on-the-vehicle machining operations. Apart from the present invention apparatus no additional or specialized tools or machines are required. The entire apparatus may be readily removed from the brake lathe to facilitate other machining operations without undue effort.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. Apparatus for machining a disk brake rotor, said apparatus comprising:
a support arbor defining a base flange and an arbor shaft, said arbor shaft having a threaded end portion and said base flange and said arbor shaft defining a center bore therethrough;
a spacer defining a spacer bore therethrough; and
a threaded fastener defining an internally threaded aperture therethrough,
said support arbor being constructed to be received upon a brake lathe arbor and to receive and support disk brake rotor and said spacer and said threaded fastener constructed to secure a disk brake rotor upon said support arbor.

2. The apparatus set forth in claim 1 wherein said threaded end portion and said internally threaded aperture define cooperating left hand threads.

3. The apparatus set forth in claim 2 wherein said apparatus includes means for securing said support arbor to a brake lathe arbor.

4. The apparatus set forth in claim 3 wherein said means for securing said support arbor to a brake lathe includes:
an arbor spacer having a bore therethrough; and
a threaded nut,
said spacer and said threaded nut being received upon a brake lathe arbor in which said threaded nut captivates said arbor spacer.

5. Apparatus for use in securing a disk brake rotor upon a brake lathe arbor of a brake lathe, said apparatus comprising:
a support arbor defining a base flange, an elongated cylindrical arbor shaft having a threaded end and a center bore extending through said base flange and said arbor shaft;
a spacer defining a center aperture;
a threaded fastener defining a threaded aperture; and
means for securing said support arbor to a brake lathe arbor,
said support arbor receiving a disk brake rotor upon said arbor shaft against said base flange and said threaded fastener being threaded upon said threaded end to captivate said spacer against a disk brake rotor upon said support arbor.

6. The apparatus set forth in claim 5 wherein said threaded fastener and said threaded end define left hand threads.

7. The apparatus set forth in claim 6 wherein said means for securing includes a threaded nut engaging a brake lathe arbor.

8. For use in supporting a disk brake rotor upon a brake lathe arbor wherein said brake lathe arbor defines a cylindrical shaft having a first threaded end, apparatus comprising:
a support arbor having a base flange, an arbor shaft having a second threaded end and a centerbore through said base flange, said arbor shaft and said second threaded end, said support arbor being received upon said brake lathe arbor by passing said brake lathe arbor through said centerbore;
a threaded fastener threadably engaging said first threaded end to secure a disk brake rotor upon said support arbor; and
means for securing said support arbor to said brake lathe arbor.

9. The apparatus set forth in claim 8 further including a first spacer interposed between said threaded fastener and a brake rotor.

10. The apparatus set forth in claim 9 wherein said threaded fastener and said second threaded end define left hand thread.

11. The apparatus set forth in claim 10 wherein said means for securing includes a threaded nut engaging said first threaded end.

12. The apparatus set forth in claim 11 wherein said means for securing includes a second spacer.
